(19) United States
(12) Patent Application Publication
(10) Pub. No.: US 2002/0021799 A1
(43) Pub. Date: Feb. 21, 2002

(54) Multi-device audio-video combines echo canceling

(76) Inventor: Paul Augustinus Peter Kaufholz, Eindhoven (NL)

Correspondence Address: U.S. Philips Corporation, 580 White Plains Road, Tarrytown, NY, 10591, US

(21) Appl. No.: 09/928,553

(22) Filed: Aug. 13, 2001

(30) Foreign Application Priority Data
Aug. 15, 2000 (EP) 00202856.1

(51) Int. Cl. H04M 9/08; H04B 3/20

(52) U.S. Cl. 379/406.03; 381/66; 704/231; 379/406.02

(57) ABSTRACT

A multi-device audio-video system contains speech recognizing facilities and echo canceling facilities. In particular, plural and functionally separate such speech recognizing facilities and echo canceling facilities are present. Now, the echo canceling facilities combine their forces for by one or more thereof canceling one or more mutually unique cancelable speech entities and combining such cancelled entities for overall non-recognition by the system.

### BACKGROUND OF THE INVENTION

The invention relates to a method for operating a multi-device audio-video system that contains speech recognizing and echo canceling facilities. More in particular, the invention relates to a method as recited in the preamble of claim 1. Now, speech recognition has gotten in wide use, such including applications in consumer systems for the general market. The echo canceling in this respect functions on an operational level in that a particular device will not recognize speech that it is presently producing itself. A human or other external user must nevertheless receive the full spectral sound being produced by the device. Thus, the canceling is effected internally in the device, whereby the sound emitted by the device itself is functionally blocked from consideration. Now, systems may be composed from various devices that each may have to recognize certain speech items from the user, it being impossible, however, to predict which items should not be recognized. In particular, the problem is aggravated in that the various devices of a particular system may come from different manufacturers. In other cases, devices may be combined that had never been intended to be operated as a combination. Devices originating from the same manufacturer or originating from different manufacturers may contain various audio sources.

### SUMMARY TO THE INVENTION

In consequence, amongst other things, it is an object of the present invention to provide a method for operating a multi-device system, wherein echo canceling has been designed on the level of the various devices, but is operative on the level of the comprehensive system.

Now therefore, according to one of its aspects, the invention is characterized according to the characterizing part of claim 1.

The invention also relates to a multi-device system so operated as claimed in claim 8. The invention also relates to a speech-enhanced device for use in a system according to the invention, as claimed in claim 15. Further advantageous aspects of the invention are recited in dependent Claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a general speech-enhanced device for use with the present invention;

FIG. 2, a multi-device speech-enhanced system with distributed automatic speech recognition (ASR) and distributed automatic echo canceling (AEC);

FIG. 3, ditto with distributed ASR and distributed AEC in a star configuration;

FIG. 4, ditto with distributed ASR and centralized AEC;

FIG. 5, ditto, with centralized ASR and centralized AEC;

FIG. 6, ditto with centralized ASR and distributed AEC;

FIG. 7, ditto with distributed ASR and distributed AEC in an advanced setup.

### DETAILED DESCRIPTION OF PREFERRED EMBODIMENTS

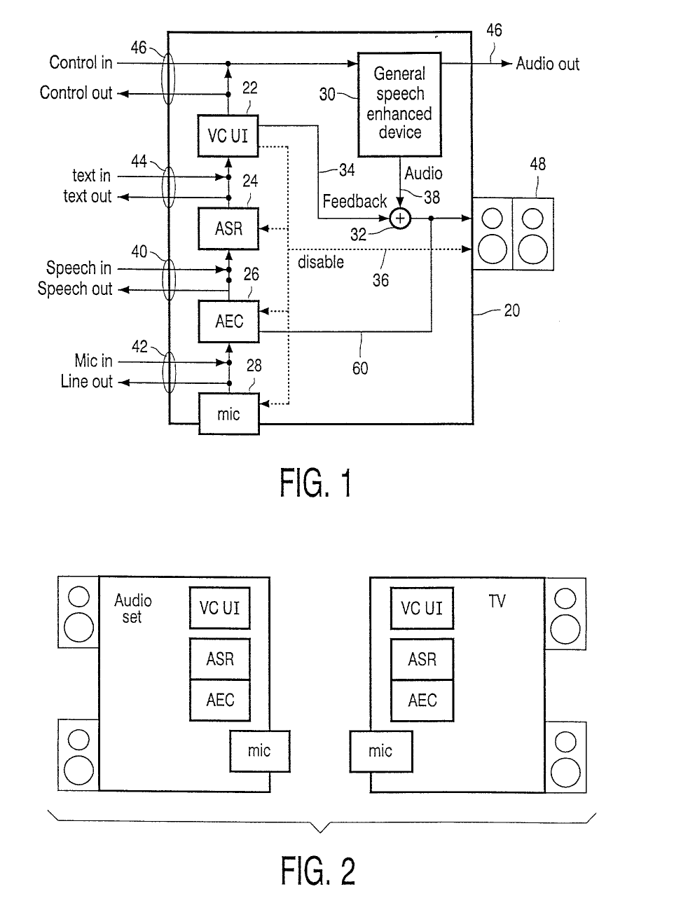

FIG. 1 illustrates a general speech-enhanced device 20 for use with the present invention. For simplicity, the prime user-directed functionality has been played down. Such functionality may, without any express or implied limitation, represent an audio or audio-video tuner, an audio player, an audio or audio-video recorder or an audio or audio-video composer. In contradistinction, the detailing of the Figure has been limited to the control functionality. Generally, user control inputting has been immediate such as symbolized by the ingoing line of bi-directional line pair 46, and such control may be mechanical through user buttons or the like, or remote through IR signaling or the like. The outputting of control signalizations has been through lamps or other visual display indicators, through text display, buzzers, and other. Furthermore, control signalizations may be exchanged through line 46 pair with other connected audio-video devices.

Item 30 represents the user functionality of the General Speech Enhanced Device, that receives external control from lines 46, and optionally produces audio on output 46 for general usability, such as broadcasted audio, and on line 38 for other purposes as will be discussed hereinafter. The latter via addition mechanism 32 is sent to loudspeakers 48. Item 22 represents a Voice-Controlled User Interface that may produce feedback on line 34 to addition mechanism 32 for thereby canceling feedback sounds from outputting on loudspeakers 48. Otherwise, item 22 may produce non-audio output on interface 46 for external usage, or for controlling device 30.

Speech input by an operator to the device may be done on microphone 28. The speech so received can be outputted on the outgoing line of line pair 42. It may also be used as an alternative to speech received on the ingoing line of line pair 42 for communicating to Automatic Echo Canceller block 26. The latter will output a speech signal on the outgoing channel of bi-directional channel 40. This speech signal closely corresponds to the speech signal received on microphone 28, from which, however, any audio signal outputted by the device via item 48 illustrated in FIG. 1 has been deleted to a great extent. Such speech signal has been received on a dedicated channel indicated by 60 in the Figure. The speech signal so corrected for the audio output of the device itself can either be outputted on the outgoing channel of bi-directional speech channel 40, or rather be sent to the input of speech recognition item 24. The latter may alternatively select to receive externally transmitted speech received on the ingoing channel of bi-directional speech channel 40. Item 24 will recognize the speech so received according to a strategy that without limitation may be conventional. The recognition result may be outputted as text on the outgoing channel of bi-directional channel pair 44, or may be forwarded to Voice-Controlled User Interface item 22. The latter may alternatively receive externally inputted text along the ingoing channel of bi-directional channel pair 44. The VCUI module 22 can produce further control signals as discussed earlier, or produce audio output for feeding to loudspeaker boxes 48, or output video display, which has not been discussed for brevity. Still further, VCUI module may generate a selective disable signal on line 36 for any or all of modules 24, 26, 28, 48 for application in cascaded architectures. The usage thereof will be discussed in detail hereinafter.

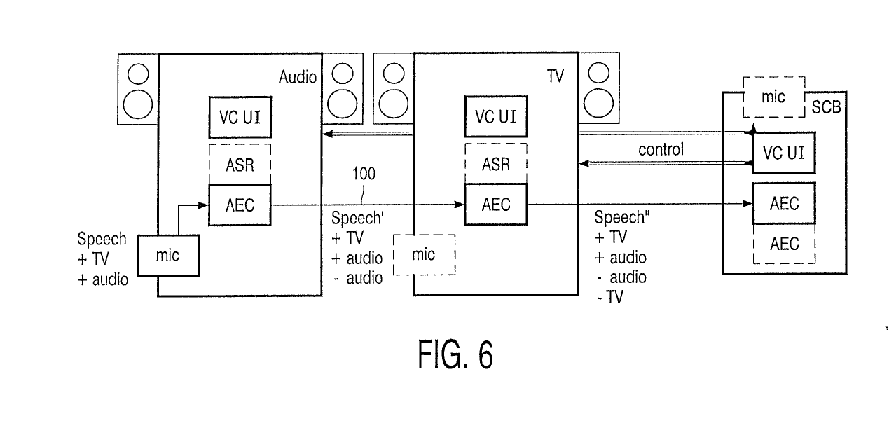

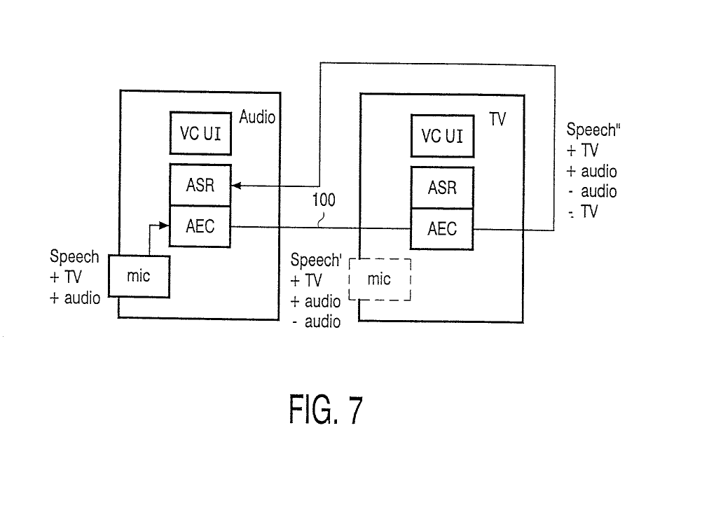

In the various embodiments, certain elements of the device of FIG. 1 may be left out. In particular, line pair 44 is optional, line out in line pair 42 may be left out, whereas certain other elements are not really necessary in one or more of the embodiments shown hereinafter. However, the microphone in line in line pair 42 will be of great usage in FIGS. 6, 7 (cf. connection 100 in particular),

FIG. 2 illustrates a multi-device speech-enhanced system with distributed automatic speech recognition (ASR) and distributed automatic echo canceling (AEC). The system has been illustrated as a combination of audio set and TV, although various other multi-device systems may be configured, such including the usage of more than two devices. In all subsequent Figures, a two-channel parallel setup such as for stereo audio or a multi-channel setup such as for use in surround sound and other sophisticated reproduction techniques may be used, without separate indication in the Figures of the various channels. Now, each device will need its own software layer for the VC User Interface. However, with such functionality built into various independent devices, the Voice Control may effectively fail when both devices are playing simultaneously. A brute-force remedy for stereo application would be to have all four channels, two for each device, and to execute echo canceling in each device separately. Internally in the device this will then require at least five channels, if also a microphone channel is required. If the number of channels rises further, the problem grows exponentially. Furthermore, the device must have enough processing power to execute at least fourfold echo canceling. The different devices must furthermore be connected to each other. Obviously, the solution so recited is both hardware and software intensive, and as such both expensive and prone to errors and malfunctioning.

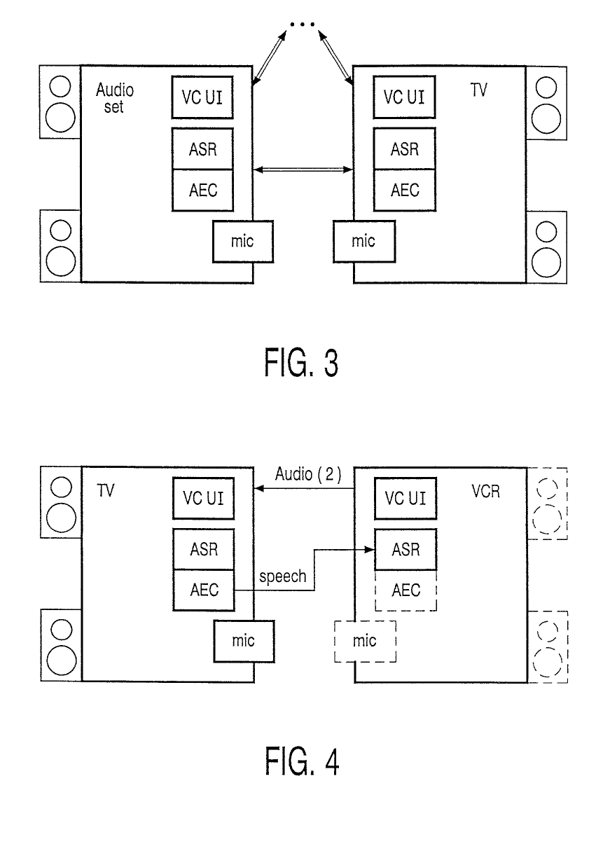

In this respect, FIG. 3 illustrates the configuration of FIG. 2 enhanced with an interconnection pattern in a star configuration. The requirements are network interconnection, audio out, and multiple channel automatic echo canceling. Note that the requirements will grow exponentially if more than two devices are making up the system, or if the number of audio channels with respect to the audio rendering will grow, such as for effecting above-HIFI quality. It is recognized that in many situations such required technical facilities would prove to be excessive.

Now, a more straightforward solution uses only a single loudspeaker, in which only a single device will output all sounds generated by any of the devices in the system.

The further Figures illustrate various non-limiting embodiments of systems according to the invention. In this respect, FIG. 4 shows such system with distributed ASR and central AEC. Now, only canceling of a single n-channel audio signal is needed, wherein n may have any realistic integer value. The wiring may often be quite simple, such as by connecting TV audio-out to an Auxiliary audio input that is often present on audio sets. Additionally however, after AEC the speech signal must be transferred to the “line in” of the other device(s) to recognize the cleaned-up signal. The speech UI remains in fact separately in each device. Additionally, further input channels may be used for future beam forming technology which requires multiple microphones and associated extra input channels. The system illustrated in the Figure is in the context of a VCR hooked up to a television set. The requirements for this approach are: speech out after echo canceling, speech in before automatic speech recognition, disable AEC, disable microphone, two-channel audio out. Note that in the VCR box the subsystems AEC, mic, and the loudspeaker s are not operational, through the selective blocking in the device of FIG. 1 as incorporated in the VCR, and as indicated by their light printing.

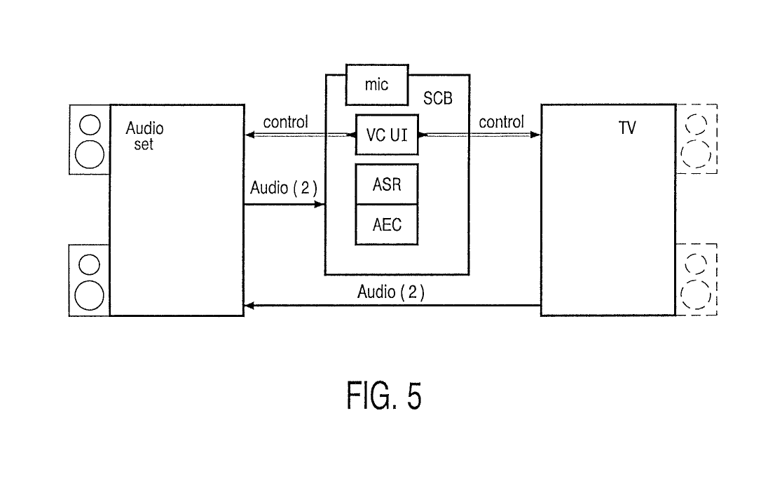

FIG. 5 illustrates a system with centralized ASR and centralized AEC, which may boil down to using a central Speech Control Box. A possible platform may be realized in a settop box. The organization realizes all advantages of the FIG. 4 configuration. Moreover, only a single speech recognizer mechanism is needed. The most apparent advantage in a user environment is the inherent absence of multiple recognizers in a single room, and furthermore, the possibility for improved controlling of various different devices and possible extension to a more powerful system. For simplicity, the Figure limits to only two devices, each with 2-channel AEC. Requirements now are: a bi-directional control link for each device, that can readily been effected through a network such as a HAVi network, audio out, and possibly, additional audio inputs for still another audio device. As far as present in the Audio Set and TV devices, all elements depictured in FIG. 1, except the Audio set's loudspeakers, will be disabled, as indicated by their having been left out from the Figure.

Now, in the setup of FIG. 5, one of the connected devices will still play the final audio via a two-channel output, which is usually effected by the audio device itself. This will force the user to connect all other devices immediately to a single audio output device. With distributed AEC, this option may be visualized as only a minor change to the SCB architecture which will allow different speech-enhanced audio devices to each play their respective own audio. Acoustic echo cancellation is done for all devices in a distributed manner, and therefore, sequentially in each separate device.

Technically, we are now using two or more ASR-AEC devices with two channels each in order to cancel two or more audio channels. For example, a speech-enhanced audio set and a speech-enhanced television set may each have their own audio output, whereas the various stereo channels will be echo-cancelled in sequence. The final and clean speech signal is used in the central SCB in order to control the various devices. Now, there are various different speech signals, all of which may be distorted. Furthermore, the delay incurred through executing the various steps in sequence may also cause problems.

In this respect, FIG. 6 illustrates another system embodiment comprising audio, TV, and SCB, with centralized ASR and distributed AEC, thus mitigating various of the above disadvantages. Particular requirements now include: speech out after echo canceling, disable ASR, disable AEC, disable microphone, line in, and bidirectional control link for each device, which may again be realized through a network. As shown, in the audio device ASR has been selectively disabled. Furthermore, in the TV, the ASR and microphone have been selectively disabled. Still further, in the SCB device, microphone and AEC have been disabled. In this setup, both audio device and television set may use their loudspeaker as shown.

In particular, the SCB may be replaced by only the connected devices, where the clean speech signal is retrocoupled to all other devices. This in fact leads to a system that resembles the option of FIG. 2 which, although perhaps being a less obvious choice, could be a very practical one nevertheless. From a packaging point of view, the key idea is to introduce robust ASR technology without the immediate need to connect all devices, and without the obligation to use exclusively the audio device for outputting the sound. This leads in fact to the option of FIG. 7 with distributed ASR and distributed AEC in an advanced setup. This scheme has the following functional requirements: speech out after Automatic Echo Canceling, disable microphone and line in. As shown, the TV set has its microphone selectively disabled.

1. A method for operating a user-interactive multi-device audio-video system that contains user speech recognizing facilities and echo canceling facilities for avoiding the recognizing of speech output from the system as user speech,
characterized in that in the presence of plural and functionally separate such speech recognizing facilities and echo canceling facilities, driving the echo canceling facilities to combine their forces for by one or more thereof canceling one or more mutually unique cancelable speech entities and combining such cancelled entities for overall non-recognition by the system.

2. A method as claimed in claim 1, wherein such combining operates by arranging various echo canceling facilities in series (FIGS. 6, 7).

3. A method as claimed in claim 2, and from said series arrangement feeding the speech recognizing facility in a centralized manner (FIG. 6).

4. A method as claimed in claim 2, and from said series arrangement feeding various speech recognizing facilities in a distributed manner (FIG. 7).

5. A method as claimed in claim 1, wherein such combining operates by centralizing said echo canceling facilities in the system and therefrom feeding various speech recognizing facilities in a distributed manner (FIG. 4).

6. A method as claimed in claim 1, wherein such combining operates by centralizing said echo canceling facilities and speech recognizing facilities in a joint control facility (FIG. 5).

7. A method as claimed in claim 1, wherein such combining operates by arranging various echo canceling facilities in a centralized control device (FIG. 4) and therefrom feeding various speech recognizing facilities in parallel.

8. A multi-device audio-video system that contains speech recognizing facilities and echo canceling facilities for avoiding the recognizing of speech output from the system as user speech,
characterized in that in the presence of plural and functionally separate such speech recognizing facilities and echo canceling facilities, the echo canceling facilities are arranged to combine their forces through joint canceling means for canceling one or more mutually unique cancelable speech entities and combining means for combining such cancelled entities for overall non-recognition by the system.

9. A system as claimed in claim 8, wherein such combining means include a serial arrangement that arranges various echo canceling facilities in series (FIGS. 6, 7).

10. A system as claimed in claim 9, arranged for from said series arrangement feeding the speech recognizing facility in a centralized manner (FIG. 6).

11. A system as claimed in claim 9, arranged for from said series arrangement feeding various speech recognizing facilities in a distributed manner (FIG. 7).

12. A system as claimed in claim 8, wherein such combining means have said echo canceling facilities centralized in a control device and are arranged for feeding various speech recognizing facilities in a distributed manner (FIG. 4).

13. A system as claimed in claim 8, wherein such combining means are arranged for centralizing said echo canceling facilities and speech recognizing facilities in a joint control facility (FIG. 5).

14. A system as claimed in claim 8, wherein such combining means are arranged for centralizing various echo canceling facilities (FIG. 4) and therefrom feeding various speech recognizing facilities in parallel.

15. A speech enhanced device for use in a system as claimed in claim 8 and having speech recognizing facilities and echo canceling facilities for avoiding the recognizing of speech output from the device as user speech,
being characterized by having speech input/output means interposed between said interconnected speech recognizing and echo canceling facilities, for intercoupling another such device.

16. A device as claimed in claim 15, and having control means for selectively disabling one or more of said speech-recognizing facilities, said echo canceling facilities and audio output facilities of the device.

17. A device as claimed in claim 15, and having microphone out means and furthermore control means for selectively controlling one or more of said speech recognizing facilities, said echo canceling facilities, and said microphone out means.
